(19) United States
(12) Patent Application Publication
(10) Pub. No.: US 2001/0033823 A1
(43) Pub. Date: Oct. 25, 2001

(54) Treated manganese ore, process for producing the same, and use thereof

(75) Inventors: Minoru Kuniyoshi, Yamaguchi (JP); Kouya Honjo, Yamaguchi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOSOH CORPORATION, Shinnanyo-shi (JP)

(21) Appl. No.: 09/824,768

(22) Filed: Apr. 4, 2001

(30) Foreign Application Priority Data
Apr. 4, 2000 (JP) 2000-106707
May 19, 2000 (JP) 2000-152754

(51) Int. Cl. C01D 5/04; C01B 17/96

(52) U.S. Cl. 423/520

(57) ABSTRACT

An object of the invention is to provide: a treated manganese ore for use in manganese sulfate production therefrom which has a high degree of manganese dissolution when dissolved in sulfuric acid and which can hence be effective in reducing the amount of slags generating in a production step and can be reduced in potassium content according to need; a process for producing the treated manganese ore easily and economically; manganese dioxide which is useful in primary batteries, secondary batteries, etc.; and a process for easily producing the manganese dioxide. A treated manganese ore for use in producing manganese sulfate therefrom, the treated ore having a degree of manganese dissolution of 98.0% by weight or higher based on the manganese contained in the treated manganese ore when dissolved in sulfuric acid; a process for producing the treated ore; manganese dioxide obtained from the treated ore; and a process for producing the manganese dioxide are described.

### FIELD OF THE INVENTION

The present invention relates to a treated manganese ore for use in producing manganese sulfate therefrom, a process for producing the same, electrolytic manganese dioxide obtained therefrom, and a process for producing the manganese dioxide. More particularly, the invention relates to a treated manganese ore in which the manganese is highly soluble in sulfuric acid and the potassium content can be reduced according to need and which is suitable for use as a material for a manganese sulfate solution to be used in, e.g., producing electrolytic manganese dioxide therefrom. The invention further relates to a process for efficiently producing the treated manganese ore and to electrolytic manganese dioxide produced from the same.

### BACKGROUND OF THE INVENTION

Manganese sulfate is a useful compound extensively used not only as a starting material for electrolytic manganese dioxide for use as a dry-battery material but as an industrial intermediate chemical for ferrite, pigments, ceramics, etc.

A manganese sulfate solution reduced in impurity content has conventionally been obtained from a naturally occurring manganese ore through the following steps: 1) a reduction step in which a naturally occurring manganese ore is reduced at a high temperature to obtain a reduced manganese ore, 2) a dissolution step in which the reduced manganese ore is dissolved in sulfuric acid to obtain a crude manganese sulfate solution, and 3) a purification step in which impurities are removed from the crude manganese sulfate solution to obtain high-purity manganese sulfate.

These steps will be explained below in order.

1) Reduction Step

Manganese oxide can exist in various forms according to the oxidation state of manganese. In naturally occurring manganese ores, such manganese oxides of various forms coexist with each other in various proportions. Since manganous oxide, among those, is the only manganese monooxide which completely dissolves in sulfuric acid, it is necessary to reduce a manganese ore to manganous monooxide prior to dissolution in sulfuric acid.

In Tetsu To Kô, Vol.49, p.971 (1963) and Tetsu To Kô, Vol.49, p.1059 (1963), there are descriptions to the effect that although manganese ores can be reduced at a temperature of 400° C. or higher, reduced manganese ores obtained through reduction at a temperature as low as 700° C. or below have a drawback that they have poor storage stability and are apt to form acid-insoluble matters when stored in an ordinary way, resulting in a reduced degree of manganese dissolution in sulfuric acid, and that for obtaining a stable reduced manganese ore, it is necessary to conduct the reduction at a temperature of 700° C. or higher, preferably about 1,000° C.

JP-B-51-30036 (the term “JP-B” as used herein means an “examined Japanese patent publication”) discloses that when reduction for obtaining a reduced manganese ore is conducted by heating at 1,093° C. or higher, ore grains sinter, making the processing difficult.

Consequently, JP-B-56-4498 and JP-B-51-30036 disclose that the reduction of a manganese ore suitable for industrial use from the standpoints of the degree of manganese reduction, rate of reduction, stability of the reduced manganese ore, heat resistance of ovens, and operation stability can be attained by reducing a pulverized manganese ore at a temperature as high as from 800 to 1,000° C. in the presence of a reducing agent such as methane gas, hydrogen gas, or carbon monoxide for a period sufficient to convert manganese oxides into manganous monooxide. However, reduction at such a high temperature of from 800 to 1,000° C. necessitates use of a castable refractory material or heat-resistant tungsten steel as the material of the reducing oven, making the apparatus highly expensive.

2) Dissolution Step

In the dissolution step, the reduced ore obtained through reduction in the reduction step described above is added to and dissolved in sulfuric acid to obtain a crude manganese sulfate solution. In this operation, metals or metal compounds such as potassium, iron, and cobalt contained as impurities in the reduced ore are also dissolved together with the manganese. The degree of manganese dissolution in sulfuric acid in the dissolution step has been lower than 98.0% by weight based on the manganese contained in the treated manganese ore.

Such a low degree of manganese dissolution from the reduced ore leads to poor profitability and has been an important subject in industrially practicing the process. Furthermore, the low degree of manganese dissolution results in the generation of a large amount of manganese-containing slags, which are difficult to utilize. The slag generation poses a problem concerning environmental preservation and has also been an important subject in industrially practicing the process.

3) Purification Step

In the purification step, iron and various heavy metals are removed from the crude manganese sulfate solution obtained in the dissolution step described above, by precipitating these impurity metals by treatment with, e.g., hydrogen sulfide. Thus, the manganese sulfate is purified. However, it has been exceedingly difficult to remove the potassium present in the crude manganese sulfate solution by the conventional method. If the potassium comes into electrolytic manganese dioxide, it exerts unfavorable influences on the performance of the dry battery. Although the following methods for potassium removal have hence been proposed, neither of these has been satisfactory.

a) Jarosite Method

In JP-A-60-166231 (the term “JP-A” as used herein means an “unexamined published Japanese patent application”) is disclosed a method which comprises adding trivalent iron to a manganese sulfate solution, adjusting the pH of the solution to thereby precipitate the potassium contained in the solution as jarosite [K₂Fe₆(SO₄)₄(OH)₁₂], which is a double salt of potassium and iron with sulfuric acid radical, and removing the precipitate by filtration. Although this jarosite method is effective in relatively easily removing potassium, it has problems that the potassium concentration of the manganese sulfate solution obtained by this method is still higher than the level currently required and that the jarosite is difficult to remove by filtration. This method further has the following problem. After the formation of jarosite, a neutralizing agent should be added to adjust the pH to around 7 in order to precipitate and remove the excess iron. It is generally known that a manganese ore is used as the neutralizing agent. However, when a manganese ore is used, the potassium contained therein dissolves in the manganese sulfate solution to increase the potassium concentration which has been lowered.

b) Water Leaching Method

Methods for removing potassium from a reduced manganese ore prior to dissolution in an acid are disclosed in JP-A-4-74720 and JP-B-47-2424. Specifically, the former discloses a method comprising treating a reduced manganese ore by heating it in an alkaline aqueous solution at a temperature of 80° C. or higher, preferably 100° C. or higher, while the latter discloses a method comprising treating a reduced manganese ore with hot water having a temperature of 100° C. or higher. However, the method in which a reduced ore is heated in an alkaline aqueous solution necessitates a large amount of an alkali, resulting in poor profitability. On the other hand, the method using hot water necessitates a large, expensive high-pressure-resistant apparatus because of the leaching temperature of 100° C. or higher although no chemicals are necessary. Thus, industrial use of these conventional methods for water leaching has serious problems concerning profitability and apparatus.

### SUMMARY OF THE INVENTION

The invention has been achieved in order to overcome various problems of the above-described conventional techniques for the production of a manganese sulfate solution. Specifically, an object of the invention is to provide a treated manganese ore for use in manganese sulfate production therefrom which has a high degree of manganese dissolution when dissolved in sulfuric acid and which can hence be effective in reducing the amount of slags generating in a production step and can be reduced in potassium content according to need. Another object of the invention is to provide a process for producing the treated manganese ore easily and economically. Still another object of the invention is to provide manganese dioxide which is produced from the treated manganese ore and is useful in primary batteries, secondary batteries, etc. A further object of the invention is to provide a process for easily producing the manganese dioxide.

The present inventors made intensive investigations on the problems of conventional techniques in order to accomplish subjects concerning the production of a manganese sulfate solution. As a result, they have found that a reduced ore obtained by reducing a manganese ore under skillfully regulated conditions has a higher degree of manganese dissolution in sulfuric acid than any conventional reduced manganese ore, and that a novel method comprising treating the reduced ore with warm water gives a treated manganese ore having an exceedingly low content of potassium soluble in sulfuric acid. They have further found that this treated manganese ore can be easily obtained. Furthermore, the inventors have found that manganese dioxide useful in primary and secondary batteries and other applications can be easily produced from the treated manganese ore having excellent properties. Thus, the invention has finally been completed.

The invention provides a treated manganese ore for use in producing manganese sulfate therefrom, the treated ore having a degree of manganese dissolution of 98.0% by weight or higher based on the manganese contained in the treated manganese ore when dissolved in sulfuric acid. The invention further provides a process for producing the treated manganese ore which comprises bringing a manganese ore as a starting material into contact with a reducing gas at a temperature of from 400 to 790° C. to obtain a reduced ore and optionally immersing the reduced ore in water having a temperature of from 70° C. to the boiling point thereof as measured at atmospheric pressure. The invention furthermore provides manganese dioxide for use in primary batteries and secondary batteries which is obtained from the treated manganese ore having such excellent properties and a process for easily obtaining the electrolytic manganese dioxide.

The objects of the present invention can be attained by the followings.

(1) A treated manganese ore for use in producing manganese sulfate therefrom, said treated ore having a degree of manganese dissolution of 98.0% by weight or higher based on the manganese contained in the treated manganese ore when dissolved in sulfuric acid.

(2) The treated manganese ore of (1), which has a degree of iron dissolution of 70% by weight or higher based on the iron contained in the treated manganese ore when dissolved in sulfuric acid.

(3) The treated manganese ore of (1) or (2), wherein the ratio of the amount of potassium soluble in sulfuric acid to that of manganese contained in the treated manganese ore (K/Mn) by weight is 0.001 or lower.

(4) The treated manganese ore of any one of (1) to (3), which is one obtained by bringing a manganese ore into contact with a reducing gas at a temperature of from 400 to 790° C.

(5) A treated manganese ore obtained by immersing the treated manganese ore of (4) in water having a temperature of from 70° C. to the boiling point thereof as measured at atmospheric pressure.

(6) The treated manganese ore of any one of (1) to (5), which has a particle size of 500 μm or smaller.

(7) A process for producing the treated manganese ore of any one of (1) to (6), which comprises bringing a manganese ore into contacted with a reducing gas at a temperature of from 400 to 790° C. to obtain a reduced ore.

(8) The process for producing a treated manganese ore of (7), wherein the manganese ore is pulverized to a particle size of 500 μm or smaller before the reduced ore is obtained therefrom.

(9) The process for producing a treated manganese ore of (7) or (8), wherein the manganese ore is kept in contact with the reducing gas at a temperature of from 400 to 790° C. for a period not shorter than the reduction saturation time.

(10) The process for producing a treated manganese ore of any one of (7) to (9), wherein the reduced ore obtained is immersed in water having a temperature of from 70° C. to the boiling point thereof as measured at atmospheric pressure.

(11) The process for producing a treated manganese ore of (10), wherein the reduced ore obtained is immersed in water having a temperature of from 70° C. to the boiling point thereof as measured at atmospheric pressure, and washed.

(12) The process for producing a treated manganese ore of (10), wherein the reduced ore obtained is immersed in water having a temperature of from 70° C. to the boiling point thereof as measured at atmospheric pressure, washed and filtered.

(13) The process for producing a treated manganese ore of any one of (7) to (12), wherein the reducing gas comprises one or more members selected from the group consisting of hydrogen, carbon monoxide, sulfur dioxide, hydrogen sulfide, and methane.

(14) The process for producing a treated manganese ore of any one of (7) to (13), wherein the reducing gas is used in an amount of from 1.0 to 2.0 times the theoretical amount thereof necessary for the reduction of the manganese ore.

(15) The process for producing a treated manganese ore of any one of (7) to (14), wherein the reducing gas is one obtained by diluting said reducing gas with an inert gas.

(16) The process for producing a treated manganese ore of any one of (7) to (15), wherein the time period of the contact of the reducing gas with the manganese ore is from 20 to 120 minutes.

(17) The process for producing a treated manganese ore of any one of (7) to (16), wherein the contact of the reducing gas with the manganese ore is conducted continuously with a rotary kiln.

(18) The process for producing a treated manganese ore of (17), wherein the rotary kiln has a cylindrical or prismatic shape.

(19) The process for producing a treated manganese ore of (17) or (18), wherein the rotary kiln is equipped with a device for mixing the ore with the reducing gas.

(20) The process for producing a treated manganese ore of (19), wherein the device for mixing the ore with the reducing gas comprises one or more movable stirring blades installed in the kiln or one or more stirring blades fixed to the inner wall of the kiln.

(21) The process for producing a treated manganese ore of any one of (7) to (20), which is conducted continuously.

(22) The process for producing a treated manganese ore of any one of (7) to (21), wherein the reduced ore is cooled in a nonoxidizing atmosphere and then immersed in water.

(23) The process for producing a treated manganese ore of any one of (10) to (21), wherein the reduced ore is immersed in water and then cooled in a nonoxidizing atmosphere.

(24) The process for producing a treated manganese ore of (22) or (23), wherein the cooling is conducted continuously.

(25) The process for producing a treated manganese ore of any one of (7) to (24), wherein the immersion of the reduced ore in water is conducted so as to yield a slurry in which the concentration of the reduced ore is from 10 to 40% by weight.

(26) The process for producing a treated manganese ore of any one of (7) to (25), wherein the immersion of the reduced ore in water is conducted for a period of from 1 to 24 hours.

(27) The process for producing a treated manganese ore of any one of (7) to (26), wherein the immersion of the reduced ore in water is conducted in one or more stirring tanks for continuous processing.

(28) Electrolytic manganese dioxide for use in batteries which is obtained by dissolving the treated manganese ore of any one of (1) to (6) in sulfuric acid, purifying the resultant solution, and electrolytically oxidizing the resultant manganese sulfate.

(29) A process for producing electrolytic manganese dioxide which comprises adding sulfuric acid to the treated manganese ore of any one of (1) to (6) to dissolve the ore and thereby obtain an aqueous solution of manganese sulfate, purifying the resultant aqueous solution of manganese sulfate, and then subjecting the solution to electrolytic oxidation to oxidize the manganese sulfate.

(30) A process for producing electrolytic manganese dioxide which comprises obtaining a treated manganese ore by the process of any one of (7) to (27), adding sulfuric acid to the treated manganese ore to dissolve the ore and thereby obtain an aqueous solution of manganese sulfate, purifying the resultant aqueous solution of manganese sulfate, and then subjecting the solution to electrolytic oxidation to oxidize the manganese sulfate.

### DETAILED DESCRIPTION OF THE INVENTION

The invention will be explained below in detail.

A naturally occurring manganese ore is used as a starting material for the treated manganese ore of the invention. Manganese ores usually contain from 20 to 60% by weight manganese and from 1 to 15% by weight iron. Preferred of these are manganese oxide ores such as, e.g., pyrolusite and psilomelane because they are mined in large quantities, have a high manganese content, and are easily available.

It is essential that the treated manganese ore of the invention have a degree of manganese dissolution in sulfuric acid of 98.0% by weight or higher based on the manganese contained in the treated manganese ore, which is exceedingly high in view of the fact that the treated manganese ores obtained by conventional techniques have a degree of manganese dissolution in sulfuric acid lower than 98.0% by weight based on the manganese contained in the treated manganese ore despite the treatment in which the manganese ore is reduced to MnO (manganese monooxide) through long-term heating at a high temperature.

The treated manganese ore of the invention, which is obtained by treating a manganese ore, has a degree of manganese dissolution in sulfuric acid as exceedingly high as 98.0% by weight or above based on the manganese contained in the treated manganese ore. This excellent property not only enables the manganese to be industrially utilized more effectively but also significantly reduces the amount of slag generation. Because of this, the treated manganese ore of the invention is exceedingly useful from the standpoints of industrial production of manganese sulfate and environmental preservation.

The term “sulfuric acid” as used herein means a general term for aqueous solutions containing sulfuric acid. Examples thereof include concentrated sulfuric acid, diluted sulfuric acid, and aqueous sulfuric acid solutions containing manganese sulfate.

The degree of dissolution in sulfuric acid of the iron contained in the treated manganese ore of the invention is preferably 70% by weight or higher, more preferably 80% by weight or higher, based on the iron contained in the treated manganese ore. Such a high degree of iron dissolution is effective in further reducing the amount of slag generation.

Furthermore, the potassium contained in the treated manganese ore of the invention can be easily removed by immersing the treated ore in water having a temperature of from 70° C. to the boiling point thereof as measured at atmospheric pressure. Hereinafter, this treated ore obtained by immersing the treated manganese ore in water having a temperature of from 70° C. to the boiling point thereof as measured at atmospheric pressure will be often referred to as “immersion-treated manganese ore”. However, in this specification, there are cases where this immersion-treated manganese ore is referred to as a treated manganese ore like the treated ore obtained by reducing a manganese ore.

This immersion-treated manganese ore is preferably one in which the ratio of the amount of potassium soluble in sulfuric acid to that of manganese contained in the treated manganese ore (K/Mn) by weight is 0.001 or lower. By thus reducing the potassium content, manganese sulfate having an exceedingly low potassium content can be produced from the treated manganese ore of the invention. As a result, a conventional operation for potassium removal can be omitted.

The particle size of the treated manganese ore of the invention is preferably 500 μm or smaller, more preferably 300 μm or smaller, because the manganese and iron ingredients contained in the treated ore particles of such a size can dissolve in sulfuric acid at an increased rate and this is effective in the production of manganese sulfate. In addition, when the treated ore obtained by reducing a manganese ore has a particle size in that range, the efficiency of potassium removal therefrom by warm-water immersion can also be improved. The reason why the rate of dissolution in sulfuric acid is related to the particle size of the treated manganese ore may be that the dissolution depends on the surface area of the treated manganese ore. If the particle size thereof is larger than 500 μm, the treated manganese ore has a reduced surface area per unit amount thereof. This means that the treated manganese ore has a smaller contact area in dissolution in sulfuric acid. Consequently, there are cases where the treated manganese ore having such a large particle size has reduced solubility and shows a lowered rate of dissolution in sulfuric acid.

The process of the invention for producing the treated manganese ore will be described next.

This process comprises bringing a manganese ore as a starting material into contact with a reducing gas at a temperature of preferably from 400 to 790° C., more preferably from 630 to 720° C., to obtain a reduced ore (hereinafter, this step is referred to as “reduction step”), and optionally further comprises immersing the reduced ore in water having a temperature of from 70° C. to the boiling point thereof as measured at atmospheric pressure (hereinafter, this step is referred to as “immersion step”).

The manganese ore used as a starting material in the process of the invention is preferably pulverized to a particle size of 500 μm or smaller, desirably 300 μm or smaller, before being subjected to the reduction step. This pulverization treatment increases the surface area of the manganese ore. As a result, the manganese ore can have an improved rate of reduction and an improved rate of potassium dissolution in producing the treated manganese ore of the invention. Although methods for the pulverization treatment are not particularly limited, preferred examples thereof include pulverization with a pulverizer such as a mill or crusher. If the manganese ore pulverized has a particle size larger than 500 μm, there are cases where the manganese ore has a reduced rate of reduction in the reduction step and where the treated manganese ore to be obtained therefrom will have a reduced rate of manganese dissolution when dissolved in sulfuric acid.

Methods for conducting the reduction step are not particularly limited However, in a preferred method for the reduction step, the manganese ore as a starting material is continuously brought into contact with a reducing gas with heating and mixing by means of an external-heating type rotary kiln to thereby accomplish the reduction.

In the case of using a rotary kiln, the reducing gas and the raw manganese ore may be passed in the rotary kiln in either the cocurrent or the countercurrent directions. However, countercurrent contact is preferred from the standpoint of heightening the efficiency of contact between the reducing gas and the ore to thereby obtain a higher degree of reduction in a shorter time period.

The rotary kiln is not particularly limited in shape as long as the ore residing therein can be efficiently stirred. However, the kiln desirably has a cylindrical or prismatic shape.

The term “cylindrical shape” means a shape whose two end faces are cricle.

The term “prismatic shape” means a shape whose two end faces are polygonal, e.g., pentagonal, hexagonal, heptagonal, or octagonal.

The rotary kiln more preferably is equipped inside with a device for mixing the ore with a reducing gas so as to heighten the efficiency of contact between the ore and the reducing gas.

Although the device for mixing the ore with a reducing gas is not particularly limited as long as it has the function of mixing the ore with the reducing gas, it is preferred to dispose a mixing device which has a simple structure, can be maintained easily, and attains an excellent efficiency of contact. Examples thereof include one or more movable stirring blades installed in the rotary kiln and one or more stirring blades fixed to the inner wall of the kiln, i.e., the so-called lifter.

A rotary kiln equipped with those mixing devices in combination may also be used.

Shapes of movable stirring blades and methods of the use thereof are described in detail in, e.g., Japanese Patent 52177, JP-B-2-46877, JP-B-2-55708, JP-B-2-55709, JP-B-2-55710, and JP-B-4-19471. The techniques shown in these prior art references can be advantageously used in the invention.

By using a rotary kiln having a shape suitable for efficiently stirring the ore residing therein as described above and/or a rotary kiln equipped with a device for mixing the ore with a reducing gas as described above, the reduction of a manganese ore according to the invention can be carried out in a shorter time period at a lower temperature with a reducing-gas amount closer to the equivalent amount.

The number of stirring blades is not particularly limited. However, the number of movable stirring blades is preferably 3 or larger and that of stirring blades fixed to the inner wall of the kiln is preferably 2 or larger, from the standpoint of heightening the efficiency of contact.

The reduction temperature in the reduction step is preferably in the range of from 400 to 790° C., more preferably in the range of from 630 to 720° C. The reasons for this are as follows. If the reduction temperature is lower than 400° C., there are cases where the raw manganese ore is reduced insufficiently to give a treated manganese ore which has an impaired degree of manganese dissolution when dissolved in sulfuric acid. On the other hand, temperatures higher than 790° C. may result in an impaired degree of manganese dissolution, making it impossible to attain a degree of manganese dissolution as high as 98.0% by weight or above based on the manganese contained in the treated manganese ore.

Furthermore, the conventional reduction of a manganese ore has necessitated use of a castable refractory material or heat-resistant tungsten steel as the material of the oven because the conventional reduction treatment is conducted at a temperature as high as from 800 to 1,000° C. Namely, highly expensive reducing ovens have been necessary. In contrast, in the reduction in the process of the invention, ordinary stainless steel can be used as an oven material and, hence, the apparatus can be produced easily at low cost.

The reducing gas to be used in the reduction step can be a gas having reducing properties, such as, e.g., hydrogen, carbon monoxide, sulfur dioxide, hydrogen sulfide, or methane. These gases can be used not only alone but in any combination of two or more thereof. Preferred of these is hydrogen mainly because it has a high reaction rate and because the reaction product gas yielded therefrom is water vapor, which does not necessitate waste gas treatment.

The amount of the reducing gas to be used is preferably at least 1.0 time the theoretical amount thereof necessary for the reduction of the raw manganese ore so as to complete the reduction reactions to yield a treated manganese ore retaining a high degree of manganese dissolution. When profitability also is taken in account, the amount thereof is preferably from 1.0 to 2.0 times the theoretical amount.

The term “theoretical amount of a reducing gas necessary for the reduction of a manganese ore” as used herein means the volumetric amount (liter) of the reducing gas necessary for reducing the higher-order manganese oxide and higher-order iron oxide contained in the manganese ore into MnO (manganese monooxide) and FeO (iron monooxide). In the case of an ore containing manganese as manganese dioxide and iron as ferric oxide, the theoretical amount of a reducing gas can be calculated using the following equation:

W=W1×(W2×0.01/55+W3×0.01×0.5/56)×0.082×T/P

(wherein W is the volumetric amount (unit: liter) of the reducing gas theoretically necessary for reducing the manganese ore; W1 is the amount (unit: g) of the manganese ore to be reduced; W2 is the manganese content (unit: wt %) in the manganese ore; W3 is the iron content (unit: wt %) in the manganese ore; T is the absolute temperature (unit: K) of the reducing gas; and P is the pressure (unit: atm) of the reducing gas).

The reducing gas to be used may be suitably diluted with an inert gas such as, e.g., nitrogen, argon, water vapor, carbon dioxide, helium, or neon. Preferred of these is nitrogen because it can be available in large quantities, can be handled easily, and is inexpensive. Use of such an inert gas is effective in lessening the dangers of the reducing gas, e.g., explosion, and in controlling the reactivity of the raw manganese ore with the reducing gas.

The time period of keeping the manganese ore in contact with a reducing gas in the reduction step is preferably not shorter than the period in which the manganese ore can be sufficiently reduced, i.e., the reduction saturation time, and is more preferably 20 minutes or longer. The term “reduction saturation time” as used herein means the period required for the manganese ore to be sufficiently reduced by a reducing gas. Whether the reduction has proceeded sufficiently can be grasped, for example, by utilizing as an index thereto the degree of dissolution of the iron contained in the ore in sulfuric acid. When the degree of iron dissolution in sulfuric acid has reached 70% by weight or higher, preferably 80% by weight or higher based on the iron contained in the treated manganese ore, the manganese ore can be judged to have been sufficiently reduced. Although the reduction saturation time varies depending on the particle size and amount of the manganese ore, amount of the reducing gas, reduction temperature, etc., it is about 30 minutes or longer at a reduction temperature of, e.g., 700° C. Reduction temperatures lower than 700° C. result in longer reduction saturation times, while reduction temperatures higher than that result in shorter reduction saturation times. By regulating the reduction period to a given time period or longer, the manganese contained in the manganese ore can be sufficiently reduced to finally give a treated manganese ore having a stably high degree of manganese dissolution in sulfuric acid. The especially preferred range of the reduction period is from 20 to 120 minutes because even when a reduction period longer than 120 minutes is used, not only the degrees of dissolution of manganese and iron do not increase any more but also the reduction uneconomically necessitates an apparatus of a larger size.

After the reduction step, the reduced ore obtained by the reduction step is preferably cooled to 150° C. or lower in a nonoxidizing atmosphere. This is because the manganese ore immediately after completion of the reduction has a temperature of several hundred degrees and is hence so unstable that it may yield acid-insoluble matters upon exposure to air. Since the rates of reactions for yielding acid-insoluble matters are low at temperatures of 150° C. or lower, the reduced ore cooled to such a temperature may be subjected to the immersion step. However, it is preferred to cool the reduced ore to room temperature.

Those reactions proceed extremely quickly. It is therefore preferred not only to prevent air inclusion during the cooling but also to pass any of the inert gases and reducing gases mentioned above or a mixture of two or more thereof through the apparatus to more effectively inhibit the generation of acid-insoluble matters.

A preferred method for the cooling is to use a rotary kiln type cooling tube to continuously cool the reduced ore while passing any of the aforementioned reducing gases and inert gases. Although an air-cooled cooling tube may be used, it is preferred to use a water-cooled cooling tube, for example, of the type in which the outer wall is showered with water, from the standpoint of heightening the efficiency of cooling to rapidly cool the reduced ore.

After the reduction step described above, a treatment for immersing the reduced ore in water, i.e., an immersion step, may be optionally conducted in order to immerse and dissolve the potassium contained in the treated manganese ore. This immersion step is accomplished by immersing the reduced manganese ore obtained in the reduction step in water, i.e., warm water, heated to a temperature of from 70° C. to the boiling point thereof as measured at atmospheric pressure.

Methods for conducting the immersion step are not particularly limited. However, in a preferred method for accomplishing the step, one or more stirring tanks for continuous processing are used to continuously stir and mix the reduced manganese ore obtained in the reduction step with warm water and the resultant slurry is continuously discharged therefrom.

The warm water to be used in the immersion step is not particularly limited as long as it is heated water. Examples thereof include pure water, ion-exchanged water, tap water, and river water from which impurities have been removed. Preferred of these are ion-exchanged water and the river water.

The temperature of the warm water is preferably not lower than 70° C. and not higher than the boiling point thereof as measured at atmospheric pressure, and is more preferably in the range of from 80 to 95° C. If the water temperature is lower than 70° C., the solubilization of potassium is insufficient. On the other hand, even when hot water having a temperature exceeding the boiling point thereof as measured at atmospheric pressure is used, the efficiency of potassium solubilization cannot be expected to be significantly improved. In addition, use of such hot water makes the process uneconomical because it necessitates a pressure apparatus.

The treatment period in the immersion step is preferably from 1 to 24 hours, more preferably from 3 to 5 hours. The reasons for this are as follows. If the treatment period is shorter than 1 hour, the solubilization of potassium may be insufficient. On the other hand, even when the treatment period exceeds 24 hours, the degree of potassium solubilization cannot be heightened any more. In addition, such too long treatment periods may necessitate a larger apparatus to impair profitability.

The concentration of the reduced manganese ore in the slurry obtained by adding warm water in the immersion step, i.e., the slurry concentration, is preferably in the range of from 10 to 40% by weight, more preferably from 20 to 30% by weight If the slurry concentration exceeds 40% by weight, there are cases where the mixing of the reduced manganese ore with the warm water becomes poor, resulting in insufficient potassium solubilization. On the other hand, even when the slurry concentration is lower than 10% by weight, the efficiency of potassium solubilization cannot be heightened any more. In addition, such low slurry concentrations may necessitate a large amount of water and a larger apparatus to impair profitability.

After completion of the immersion step, the treated manganese ore obtained is desirably washed in order to heighten reproducibility and operating efficiency and remove impurities like as a potassium. Water is usually used for the washing. Examples thereof include pure water, ion-exchanged water, tap water, and river water from which impurities have been removed. Preferred of these are ion-exchanged water and the river water. The washing water is used desirably in an amount of from 1 to 10 times by volume the amount of the cake of the treated manganese ore. Although the number of washing operations is not particularly limited, it is desirably from 1 to 10.

After the washing, the slurry maybe directly subjected to dissolution in an acid. It is, however, desirable from the standpoint of water balance that the slurry be separated by sedimentation or filtered by means of a filter press, centrifugal separation, belt filter, etc. and the resultant cake be subjected to dissolution in an acid. This slurry can be easily separated into the solid and the liquid, so that the treated manganese ore can be easily separated by an ordinary technique for solid/liquid separation.

In the invention, the steps and operations described above can be carried out either batchwise or continuously. However, they are preferably conducted in a continuous manner capable of realizing a compacter equipment, improvement in operation efficiency, and improvement in productivity. Methods for continuous operations are suitably selected according to the starting material, scale of production, etc. These steps may be mutually combined organically. Furthermore, use may be made of a method in which a treated product obtained in one step is stored and thereafter subjected to the next step either alone or together with treated products successively obtained in that step.

The process of the invention for producing a treated manganese ore can be carried out easily, safely, and efficiently at low cost without using any special apparatus or expensive chemical. The process is hence industrially useful. Furthermore, the removal of potassium by immersion treatment with warm water is effective in removing at least 80% of the sodium, which is in the same group as potassium, contained in the raw manganese ore.

Conventional methods for removing potassium from a reduced ore are highly costly and necessitate a special apparatus and much labor because an expensive alkali is used to heat-treat the ore or an expensive pressure apparatus such as, e.g., an autoclave is used to treat the ore with hot water having a temperature of 100° C. or higher. These conventional methods have hence been difficult to practice industrially. In contrast, the treated ore obtained by treating a reduced manganese ore through immersion in warm water by the process of the invention has high storage stability and is less apt to yield an acid-insoluble matter. Although the reasons for this are uncertain, it is presumed that particles of the treated manganese ore are covered with a film of water and this water film inhibits the formation of an acid-insoluble matter.

However, this presumption should not be construed as limiting the scope of the invention in any way.

The treated manganese ore of the invention can be obtained by the process described above.

As compared with conventional treated manganese ores, the treated manganese ore of the invention is exceedingly reduced in the amount of slag generation since the manganese and iron contained therein have a high degree of dissolution in sulfuric acid. Because of this, in the case where the treated manganese ore of the invention is used as, e.g., a starting material in producing electrolytic manganese dioxide for use as a dry-battery material, the manganese dioxide can be efficiently produced while attaining a reduced loss, etc.

Consequently, the treated manganese ore of the invention is useful also as a starting material for manganese dioxide to be used in primary batteries and secondary batteries. In this application, the treated manganese ore of the invention can be used in the following manner. The treated manganese ore is added as a starting material to sulfuric acid, e.g., dilute sulfuric acid, and dissolved therein to thereby produce a solution of manganese sulfate. The resultant aqueous solution of manganese sulfate is treated in an ordinary manner to remove impurities such as iron and heavy metals therefrom. This purified solution is subjected to electrolytic oxidation to oxidize the manganese sulfate. Thus, electrolytic manganese dioxide can be produced.

The production of manganese dioxide from the treated manganese ore of the invention has the following advantages. Since the manganese and iron contained in the treated manganese ore have a high degree of dissolution in sulfuric acid, the amount of slag generation is exceedingly small as compared with manganese dioxide production from conventional manganese ores, leading to environmental preservation. Furthermore, an aqueous manganese sulfate solution and electrolytic manganese dioxide can be efficiently produced without causing a loss of manganese from the starting material.

In addition, since the treated ore obtained by reducing a manganese ore and treating the resultant reduced ore by immersion in water having a temperature not higher than the boiling point thereof as measured at atmospheric pressure has an exceedingly low potassium content, a conventional operation for potassium removal by an ordinary method can be omitted in obtaining an aqueous manganese sulfate solution for use in producing electrolytic manganese dioxide therefrom. Thus, an aqueous manganese sulfate solution and electrolytic manganese dioxide can be produced efficiently, leading to the effective utilization of resources.

The invention will be explained below in more detail by reference to Examples, but the invention should not be construed as being limited to these Examples. The contents of manganese, iron, and potassium were determined in terms of the weights of the atoms of the respective elements contained in the manganese ingredients, iron ingredients, and potassium ingredients.

### EXAMPLE 1

A manganese dioxide ore containing 52.15% by weight manganese and 2.63% by weight iron was pulverized to a particle size of 300 μm or smaller. The pulverized ore was introduced into an external-heating type rotary kiln having an inner diameter of 200 mm and a length of 4 m at a rate of 1,100 g/min and, simultaneously therewith, hydrogen gas diluted with nitrogen to a hydrogen concentration of 40% by volume was introduced into the same kiln in an amount of 1.2 times the equivalent amount for reduction reaction so as to countercurrently contact the ore with the gas. Thus, reducing roasting was conducted. The reduction temperature and reduction period were set at 650° C. and 90 minutes, respectively. The reduced ore obtained was cooled to 50° C. or lower in a nitrogen gas stream to obtain a reduced manganese ore having a manganese content of 64.30% by weight and an iron content of 2.91% by weight. The treated manganese ore obtained was analyzed by screening with sieves. As a result, the particle size thereof was found to be 300 μm or smaller.

This treated manganese ore was dissolved in 3.0% by weight sulfuric acid heated to 90° C. in such an amount as to result in a pH of 1.5. The resultant mixture was separated by filtration into a manganese sulfate solution and a slag. As a result, the amount of the slag on a dry basis was 0.06 kg per kg of the raw manganese ore. Analysis of this slag by an ordinary method revealed that when the treated manganese ore obtained was dissolved in the dilute sulfuric acid, a degree of manganese dissolution was 99.9% by weight based on the manganese contained in the raw manganese ore and a degree of iron dissolution was 89.9% by weight based on the iron contained in the raw manganese ore.

### COMPARATIVE EXAMPLE 1

A manganese dioxide ore containing 52.15% by weight manganese and 2.63% by weight iron was pulverized to a particle size of 300 μm or smaller. The pulverized ore was introduced into an external-heating type rotary kiln having an inner diameter of 200 mm and a length of 4 m at a rate of 1,100 g/min and, simultaneously therewith, CO gas diluted with nitrogen to a CO concentration of 40% by volume was introduced into the same kiln in an amount of 1.2 times the equivalent amount for reduction reaction so as to countercurrently contact the ore with the gas. Thus, reducing roasting was conducted. The reduction temperature and reduction period were set at 1,000° C. and 120 minutes, respectively. The reduced ore obtained was cooled to room temperature in a nitrogen gas stream to obtain a treated manganese ore having a manganese content of 62.96% by weight and an iron content of 4.04% by weight. The treated manganese ore obtained was analized by screening with sieves. As a result, the particle size thereof was found to be 300 μm or smaller.

This treated manganese ore was dissolved in 3.0% by weight sulfuric acid heated to 90° C. in such an amount as to result in a pH of 1.5. The resultant mixture was separated by filtration into a manganese sulfate solution and a slag. As a result, the amount of the slag on a dry basis was 0.14 kg per kg of the raw manganese ore. Analysis of this slag by an ordinary method revealed that when the treated manganese ore obtained was dissolved in the dilute sulfuric acid, a degree of manganese dissolution was 95.4% by weight based on the manganese contained in the raw manganese ore and a degree of iron dissolution was 42.3% by weight based on the iron contained in the raw manganese ore.

A comparison between Example 1 and Comparative Example 1 given above shows that the manganese ore in Example 1 was reduced more sufficiently than in Comparative Example 1, so that the treated manganese ore obtained in Example 1 had higher degrees of manganese dissolution and iron dissolution in dilute sulfuric acid.

### EXAMPLE 2

A manganese dioxide ore containing 52.2% by weight manganese, 2.63% by weight iron, and 5,750 ppm (0.575% by weight) potassium was pulverized to a particle size of 300 μm or smaller. The pulverized ore was introduced into an external-heating type rotary kiln having an inner diameter of 200 mm and a length of 4 m at a rate of 1,100 g/min and, simultaneously therewith, hydrogen gas diluted with nitrogen to a hydrogen concentration of 40% by volume was introduced into the same kiln in an amount of 1.2 times the equivalent amount for reduction reaction so as to countercurrently contact the ore with the gas. Thus, reducing roasting was conducted. The reduction temperature and reduction period were set at 700° C. and 30 minutes, respectively. The resultant reduced ore was cooled to 50° C. or lower in a nitrogen gas stream and then introduced into a stirring tank, in which the reduced ore was treated with 90° C. warm water for 5 hours at a slurry concentration of 20% by weight. The ore was then washed and recovered by filtration to obtain a treated manganese ore according to the invention for manganese sulfate production, which had a manganese content of 37.4% by weight, iron content of 1.71% by weight, and potassium content of 279 ppm (0.0279% by weight). This treated manganese ore was analyzed by wet screening with sieves. As a result, the particle size thereof was found to be 300 μm or smaller.

In 3.0% by weight aqueous sulfuric acid solution heated to 90° C. was dissolved 13.3 g of the treated manganese ore so as to result in a pH of 1.5. This mixture was separated by filtration into a manganese sulfate solution and a slag. The resultant sulfuric acid solution had a manganese content of 1.35% by weight, iron content of 486 ppm (0.0486% by weight), and potassium content of 6 ppm (0.000006% by weight). The slag weighed 0.48 g and had a manganese content of 0.69% by weight, iron content of 10.9% by weight, and potassium content of 2,460 ppm. These results show that the degree of manganese dissolution when the treated manganese ore obtained was dissolved in the sulfuric acid (hereinafter referred to simply as “degree of manganese dissolution”) was 99.9% by weight based on the manganese contained in the raw manganese ore and the degree of iron dissolution when the treated manganese ore obtained was dissolved in the sulfuric acid (hereinafter referred to simply as “degree of iron dissolution”) was 76.8% by weight based on the iron contained in the raw manganese ore, and that the ratio of the amount of potassium soluble in sulfuric acid to that of manganese contained in the treated manganese ore by weight (hereinafter referred to as “K/Mn”) was 0.000507. The results obtained are shown in Table 1.

TABLE 1

| | | | | | | | | | | | | Properties of treated | | |
|---|---|---|---|---|---|---|---|---|---|---|---|---|---|---|
| | | | | | | | | | | | | manganese ore | | |
| | | | | | | | | | | | | Degree | Degree | |
| | | | | Amount | | | | | | | | of man- | of | |
| | | | | of | | | | | | | | ganese | iron | |
| | Composition of treated | | | treated | Composition of sulfuric | | | | | | | dis- | dis- | |
| | manganese ore | | | manga- | acid solution | | | Slag | Composition of slag | | | solu- | solu- | K/Mn |
| Example | Mn | Fe | K | nese ore | Mn | Fe | K | amount | Mn | Fe | K | tion | tion | weight |
| No. | (wt %) | (wt %) | (wt %) | (g) | (wt %) | (wt %) | (wt %) | (g) | (wt %) | (wt %) | (wt %) | (%) | (%) | ratio |
| Example 2 | 37.4 | 1.71 | 0.0279 | 13.3 | 1.35 | 0.0486 | 0.0006 | 0.48 | 0.69 | 10.9 | 0.2460 | 99.9 | 76.8 | 0.000507 |
| Example 3 | 38.1 | 1.72 | 0.0324 | 15.1 | 1.37 | 0.0542 | 0.0008 | 0.51 | 1.75 | 5.72 | 0.2720 | 99.8 | 88.7 | 0.000608 |
| Example 4 | 37.5 | 1.70 | 0.0416 | 15.3 | 1.36 | 0.0540 | 0.0012 | 0.50 | 1.69 | 4.99 | 0.2560 | 99.9 | 90.4 | 0.000887 |
| Example 5 | 30.7 | 1.35 | 0.0444 | 16.1 | 1.36 | 0.0563 | 0.0015 | 0.42 | 2.96 | 1.29 | 0.8320 | 99.8 | 97.5 | 0.000749 |
| Example 6 | 38.3 | 1.64 | 0.0348 | 16.0 | 1.35 | 0.0562 | 0.0011 | 0.41 | 1.80 | 4.87 | 0.2860 | 99.9 | 92.4 | 0.000765 |
| Compar- | 40.7 | 1.99 | 0.1020 | 13.4 | 1.38 | 0.0073 | 0.0035 | 1.93 | 34.20 | 12.1 | 0.0580 | 87.9 | 12.1 | 0.002290 |
| ative | | | | | | | | | | | | | | |
| Example 2 | | | | | | | | | | | | | | |
| Compar- | 47.9 | 3.02 | 0.3790 | 13.7 | 1.36 | 0.0243 | 0.0095 | 1.77 | 17.21 | 16.0 | 0.5310 | 95.4 | 31.6 | 0.006500 |
| ative | | | | | | | | | | | | | | |
| Example | | | | | | | | | | | | | | |
| 3 | | | | | | | | | | | | | | |

Furthermore, sulfuric acid was added to the treated manganese ore. The ore was dissolved in the acid to obtain a manganese sulfate solution. An aqueous hydrogen peroxide solution was added to the aqueous manganese sulfate solution, and the resultant mixture was neutralized with milk of lime. After the solid was removed by filtration, the residual manganese sulfate solution was subjected to electrolytic oxidation at a temperature of 90° C. and a current density of 1.0 A/dm². Thus, high-purity electrolytic manganese dioxide for use in batteries was obtained.

### EXAMPLE 3

A treated manganese ore was obtained in the same manner as in Example 2, except that the reduction period was set at 90 minutes. This treated manganese ore for manganese sulfate production was analyzed by wet screening with sieves. As a result, the particle size thereof was found to be 300 μm or smaller.

15.1 g of this treated manganese ore was treated in the same manner as in Example 2 to determine the degree of manganese dissolution, degree of iron dissolution, and K/Mn. The results obtained are shown in Table 1.

### EXAMPLE 4

A treated manganese ore was obtained in the same manner as in Example 2, except that the reduction period was set at 90 minutes and the period of the warm-water treatment was changed to 3 hours. This treated manganese ore for manganese sulfate production was analyzed by wet screening with sieves. As a result, the particle size thereof was found to be 300 μm or smaller.

15.3 g of this treated manganese ore was treated in the same manner as in Example 2 to determine the degree of manganese dissolution, degree of iron dissolution, and K/Mn. The results obtained are shown in Table 1.

### EXAMPLE 5

A treated manganese ore was obtained in the same manner as in Example 2, except that hydrogen gas diluted with nitrogen to a hydrogen concentration of 20% by volume was used in an amount of 2.0 times the equivalent amount for reduction reaction, that the reduction temperature and reduction period were set at 710° C. and 90 minutes, respectively, and that the slurry concentration was changed to 40% by weight. This treated manganese ore for manganese sulfate production was analyzed by wet screening with sieves. As a result, the particle size thereof was found to be 300 μm or smaller.

16.1 g of this treated manganese ore was treated in the same manner as in Example 2 to determine the degree of manganese dissolution, degree of iron dissolution, and K/Mn. The results obtained are shown in Table 1.

### EXAMPLE 6

A treated manganese ore was obtained in the same manner as in Example 2, except that hydrogen gas diluted with nitrogen to a hydrogen concentration of 90% by volume was used in an amount of 1.6 times the equivalent amount for reduction reaction, that the reduction period was set at 90 minutes, and that the temperature of the warm water was changed to 80° C. This treated manganese ore for manganese sulfate production was analyzed by wet screening with sieves. As a result, the particle size thereof was found to be 300 μm or smaller.

16.0 g of this treated manganese ore was treated in the same manner as in Example 2 to determine the degree of manganese dissolution, degree of iron dissolution, and K/Mn. The results obtained are shown in Table 1.

### COMPARATIVE EXAMPLE 2

A treated manganese ore was obtained in the same manner as in Example 2, except that the reduction temperature and reduction period were set at 350° C. and 60 minutes, respectively, and that the temperature of the warm water was changed to 80° C. This treated manganese ore for manganese sulfate production was analyzed by wet screening with sieves. As a result, the particle size thereof was found to be 300 μm or smaller.

13.4 g of this treated manganese ore was treated in the same manner as in Example 2 to determine the degree of manganese dissolution, degree of iron dissolution, and K/Mn. The results obtained are shown in Table 1.

### COMPARATIVE EXAMPLE 3

A treated manganese ore was obtained in the same manner as in Example 2, except that CO gas was used as a reducing gas, that the reduction temperature and reduction period were set at 1,000° C. and 120 minutes, respectively, and that the reduced ore was cooled to room temperature in a nitrogen gas stream, subsequently introduced into an autoclave stirring tank, and then treated therein with 110° C. hot water. This treated manganese ore for manganese sulfate production was analyzed by wet screening with sieves. As a result, the particle size thereof was found to be 300 μm or smaller.

13.7 g of this treated manganese ore was treated in the same manner as in Example 2 to determine the degree of manganese dissolution, degree of iron dissolution, and K/Mn. The results obtained are shown in Table 1.

The invention produces the following effects.

1) The treated manganese ore of the invention has an exceedingly high degree of manganese dissolution when dissolved in sulfuric acid, and this property makes the treated ore highly suitable for use in obtaining a manganese sulfate solution for producing electrolytic manganese dioxide therefrom. Furthermore, the treated manganese ore is extremely reduced in the amount of slag generation as compared with conventional reduced manganese ores. The treated manganese ore is hence extremely useful in practical use.

2) When the treated manganese ore of the invention obtained through a reduction treatment is treated with warm water, a treated manganese ore having a reduced potassium content is obtained. This treated manganese ore has properties which make the treated ore highly suitable for use in obtaining a high-purity manganese sulfate solution for producing electrolytic manganese dioxide therefrom.

3) The process of the invention for producing a treated manganese ore necessitates neither a reducing apparatus or pressure apparatus made of an expensive material nor an expensive alkali. By treating with warm water the treated manganese ore of the invention obtained through a reduction treatment, a treated manganese ore can be obtained which gives a manganese sulfate solution having an exceedingly reduced potassium concentration and further having an exceedingly reduced concentration of alkali metals such as sodium, which are in the same group as potassium. Thus, a treated manganese ore for use in producing high-quality manganese sulfate therefrom can be easily produced. Furthermore, the equipment cost is low. The process is suitable for mass production and industrial use.

4) The process of the invention for producing electrolytic manganese dioxide uses the treated manganese ore of the invention, having an extremely low impurity content, as a starting material. Consequently, the burden imposed on a step for impurity removal can be lessened and the process is extremely useful industrially. The manganese dioxide for batteries obtained from that starting material is of high quality.

While the invention has been described in detail and with reference to specific embodiments thereof, it will be apparent to one skilled in the art that various changes and modifications can be made therein without departing from the spirit and scope thereof.

What is claimed is:

1. A treated manganese ore for use in producing manganese sulfate therefrom, said treated ore having a degree of manganese dissolution of 98.0% by weight or higher based on the manganese contained in the treated manganese ore when dissolved in sulfuric acid.

2. The treated manganese ore of claim 1, which has a degree of iron dissolution of 70% by weight or higher based on the iron contained in the treated manganese ore when dissolved in sulfuric acid.

3. The treated manganese ore of claim 1, wherein the ratio of the amount of potassium soluble in sulfuric acid to that of manganese contained in the treated manganese ore (K/Mn) by weight is 0.001 or lower.

4. The treated manganese ore of claim 1, which is one obtained by bringing a manganese ore into contact with a reducing gas at a temperature of from 400 to 790° C.

5. A treated manganese ore obtained by immersing the treated manganese ore of claim 4 in water having a temperature of from 70° C. to the boiling point thereof as measured at atmospheric pressure.

6. The treated manganese ore of claim 1 or 5, which has a particle size of 500 μm or smaller.

7. A process for producing the treated manganese ore for use in producing manganese sulfate therefrom, said treated ore having a degree of manganese dissolution of 98.0% by weight or higher based on the manganese contained in the treated manganese ore when dissolved in sulfuric acid, which comprises bringing a manganese ore into contacted with a reducing gas at a temperature of from 400 to 790° C. to obtain a reduced ore.

8. The process for producing a treated manganese ore of claim 7, wherein the manganese ore is pulverized to a particle size of 500 μm or smaller before the reduced ore is obtained therefrom.

9. The process for producing a treated manganese ore of claim 7, wherein the manganese ore is kept in contact with the reducing gas at a temperature of from 400 to 790° C. for a period not shorter than the reduction saturation time.

10. A process for producing the treated manganese ore for use in producing manganese sulfate therefrom, said treated ore having a degree of manganese dissolution of 98.0% by weight or higher based on the manganese contained in the treated manganese ore when dissolved in sulfuric acid, which comprises bringing a manganese ore into contacted with a reducing gas at a temperature of from 400 to 790° C. to obtain a reduced ore, and the reduced ore obtained is immersed in water having a temperature of from 70° C. to the boiling point thereof as measured at atmospheric pressure.

11. The process for producing a treated manganese ore of claim 10, wherein the reduced ore obtained is immersed in water having a temperature of from 70° C. to the boiling point thereof as measured at atmospheric pressure, and washed.

12. The process for producing a treated manganese ore of claim 10, wherein the reduced ore obtained is immersed in water having a temperature of from 70° C. to the boiling point thereof as measured at atmospheric pressure, washed and filtered.

13. The process for producing a treated manganese ore of claim 7, wherein the reducing gas comprises one or more members selected from the group consisting of hydrogen, carbon monoxide, sulfur dioxide, hydrogen sulfide, and methane.

14. The process for producing a treated manganese ore of claim 7, wherein the reducing gas is used in an amount of from 1.0 to 2.0 times the theoretical amount thereof necessary for the reduction of the manganese ore.

15. The process for producing a treated manganese ore of claim 13, wherein the reducing gas is one obtained by diluting said reducing gas with an inert gas.

16. The process for producing a treated manganese ore of claim 7, wherein the time period of the contact of the reducing gas with the manganese ore is from 20 to 120 minutes.

17. The process for producing a treated manganese ore of claim 7, wherein the contact of the reducing gas with the manganese ore is conducted continuously with a rotary kiln.

18. The process for producing a treated manganese ore of claim 17, wherein the rotary kiln has a cylindrical or prismatic shape.

19. The process for producing a treated manganese ore of claim 17, wherein the rotary kiln is equipped with a device for mixing the ore with the reducing gas.

20. The process for producing a treated manganese ore of claim 19, wherein the device for mixing the ore with the reducing gas comprises one or more movable stirring blades installed in the kiln or one or more stirring blades fixed to the inner wall of the kiln.

21. The process for producing a treated manganese ore of claim 7, which is conducted continuously.

22. The process for producing a treated manganese ore of claim 8, which is conducted continuously.

23. The process for producing a treated manganese ore of claim 10, which is conducted continuously.

24. The process for producing a treated manganese ore of claim 10, wherein the reduced ore is cooled in a nonoxidizing atmosphere and then immersed in water.

25. The process for producing a treated manganese ore of claim 10, wherein the reduced ore is immersed in water and then cooled in a nonoxidizing atmosphere.

26. The process for producing a treated manganese ore of claim 24, wherein the cooling is conducted continuously.

27. The process for producing a treated manganese ore of claim 25, wherein the cooling is conducted continuously.

28. The process for producing a treated manganese ore of claim 10, wherein the immersion of the reduced ore in water is conducted so as to yield a slurry in which the concentration of the reduced ore is from 10 to 40% by weight.

29. The process for producing a treated manganese ore of claim 10, wherein the immersion of the reduced ore in water is conducted for a period of from 1 to 24 hours.

30. The process for producing a treated manganese ore of claim 10, wherein the immersion of the reduced ore in water is conducted in one or more stirring tanks for continuous processing.

31. Electrolytic manganese dioxide for use in batteries which is obtained by dissolving the treated manganese ore of claim 1 or 5 in sulfuric acid, purifying the resultant solution, and electrolytically oxidizing the resultant manganese sulfate.

32. A process for producing electrolytic manganese dioxide which comprises adding sulfuric acid to the treated manganese ore of claim 1 or 5 to dissolve the ore and thereby obtain an aqueous solution of manganese sulfate, purifying the resultant aqueous solution of manganese sulfate, and then subjecting the solution to electrolytic oxidation to oxidize the manganese sulfate.

33. A process for producing electrolytic manganese dioxide which comprises obtaining a treated manganese ore by the process of claim 7, adding sulfuric acid to the treated manganese ore to dissolve the ore and thereby obtain an aqueous solution of manganese sulfate, purifying the resultant aqueous solution of manganese sulfate, and then subjecting the solution to electrolytic oxidation to oxidize the manganese sulfate.
